(19) United States
(12) Patent Application Publication
(10) Pub. No.: US 2005/0173524 A1
(43) Pub. Date: Aug. 11, 2005

(54) Vehicle information system

(76) Inventor: Jeffrey L. Schrader, Beaver, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 10/861,124

(22) Filed: Jun. 4, 2004

Related U.S. Application Data
(60) Provisional application No. 60/542,914, filed on Feb. 9, 2004.

(51) Int. Cl. G07B 15/02; G06K 7/10

(52) U.S. Cl. 235/384; 235/462.01

(57) ABSTRACT

The present invention relates to a system and a method for obtaining information associated with a vehicle through the use of a barcode attached to a vehicle. The barcode is adapted for transmission of an identifiable signal by a scanner. The signal is decoded and displayed directly and or matched to data in one or more database. The matched data is displayed.

### CROSS-REFERENCES TO RELATED APPLICATIONS

This application claims priority to U.S. Provisional Application No. 60/542,914 filed Feb. 9, 2004.

### FIELD OF THE INVENTION

The present invention relates to a system for accessing information associated with a vehicle by reading a barcode disposed on a vehicle.

### BACKGROUND OF THE INVENTION

A vehicle registration plate, or license plate, typically provides limited information, such as the vehicle registration number, the state in which the vehicle is registered, and the expiration date of the registration. In order for a person, such as a law enforcement officer, security personnel, or the like, to obtain more information about the vehicle, s/he must accurately identify the registration number. After obtaining the number, s/he may visually check it against a written list, manually input it into a computer system, or orally relate it to a second person. The computer entry and transmission of the registration number to the second person must also be accurate. The relayed number must be accurately understood by the second person and accurately checked against a list or entered into a computer, where it is typically compared to information contained in files in a database. Where a match is determined, the information must be accurately relayed back to the originator. The opportunity for error exists at each step. Each of these steps also consumes time and resources. For personnel who need data about a particular vehicle, such as a law enforcement officer who enforces laws pertaining to vehicles, the ability to obtain information regarding that vehicle quickly and correctly is vitally important.

In routine vehicle registration with a state entity as well as other registrations, the data associated with the registration number is typically limited to the activity. Law enforcement personnel use the registration numbers to determine knowledge about a particular vehicle for stolen vehicle checks, traffic stops, abandoned vehicle, and the like. Security personnel may compare the registration number against a pre-existing list to determine access to parking facilities, pre-paid events, gated communities, secured facilities, and the like. Regulatory personnel may use a registration number for such purposes as tracking a vehicle across state lines or to accessing specific information, such as the weight of a commercial trailer of a truck after loading. The personnel associated with these activities, as well as other existing and future activities, would benefit from additional information associated with the existing information about a vehicle. Linking existing information would also be useful. A system that has the ability to link to other databases to gather, update, and/or create new information associated with a vehicle would be beneficial.

Alternative means to identify a vehicle, such as smart cards and digital converters that take a picture of the vehicle's license plate, are in existence but have disadvantages. While smart cards may include more information about the vehicle, they normally require a power source and may not be up-to-date, in that the data stored on the card must be periodically uploaded from another source, such as a central database. If the database information is updated, the smart card will continue to hold the old data until an update of the card itself occurs. Digital converters require expensive cameras and are prone to inaccuracies based on the ability of the software to correctly interpret and convert the picture into alphanumeric characters. Depending on the sophistication of the software, the conversion process may consume a significant amount of time. A need exists for a relatively inexpensive, low maintenance system that has the ability to rapidly provide accurate up-to-date information.

Barcoding is a technology that has been used and improved for over 50 years. Barcodes use alphanumerics or symbols to represent data, such ASCII characters that convey information. The barcode information may be direct information, such as a manufacturer name and product number, or indirect information, such as a number that is associated with a searchable file of information. Barcodes are typically optically read by a scanner that captures the image of the barcode and converts it to computer-compatible data.

There are also different types of barcodes. Some barcodes use characters, such as letters, numbers, punctuations, etc. Some barcodes use computer generated symbols. Linear barcodes, such as the UPC barcode used to identify items at a grocery store, have different width bars that encode letters and numbers. Linear barcodes are numeric and may be used to indicate simple data. 128 barcodes are more flexible than linear barcodes in that they contain all 128 ASCII characters, which allows for more data. 2D barcodes, which have different sized squares to represent data, can hold even more characters to encode a larger amount of data.

Barcode technologies typically use guard bars at either end and a checksum for error detection, and include deliberate redundancies to allow for reconstruction if the barcode is damaged. As a result, barcodes have a very high accuracy in being read.

Scanners used to decode barcodes have also advanced in the last 50 years. Wireless technology and long-range capability are recent improvements. Many scanners can now be used in extreme environments, such as rain and low temperatures. The scanning can be one dimensional or multi-dimensional. Long range scanning may require a highly reflective barcode. Wireless scanners are coded to link the scanner to a base station. Wireless technology allows more than one scanner to operate in the same area without interference. Most barcode scanners collect light reflected from the barcode and convert the amount of reflected light into digital data. Scanning may also be done electronically using a charge-coupled device (CCD) element. The digital data is decoded into a string of ASCII characters, which are able to be processed by a computer.

Adapting barcode technology to obtain and/or update information about a vehicle would reduce the amount of time used in conventional methods, such as trying to decipher the registration number, transmitting it directly or indirectly to be matched to previously established data and obtaining information associated with the match. Barcode technology further offers error reduction and potential lower costs than existing methodologies.

### SUMMARY OF THE INVENTION

The invention described is a vehicle information system comprising a barcode attached to a vehicle and a barcode scan engine capable of scanning barcodes and decoding and transferring the characters or symbols encoded in barcodes directly to a display or to a processor. In the direct display, the barcode contains information that can be decoded by the scanner and displayed on a display or monitor, which may be included in the scanner or as a separate component. If the system uses the processor, the barcode may contain a reference, such as a number, that is compared and matched to data stored in at least one database by at least the processor. The reference may also be compared to other databases linked to the processor. For searches, the processor may be private, intranet based or linked to a communication network, such as the Internet. The processor is also linked to the display and is programmed to relay matched information to the display.

The scanner may be hand-held or stationary and is linked to the processor either through a wired or wireless communication link. The system may use a one-dimensional, multidimensional or other type of barcode scanner. The processor may be located near the scanner or at a remote site. Communications between the processor and the scanner when the scanner is remotely located can be via a wireless or wired communications link.

The processor may be programmed to transmit any information found in any database to the display or may be programmed to transmit specific information based on the scanner source.

The one or more database of the system comprises identifiable individual files. The files may be directed to information concerning vehicle status, including routine information and alert information, such as listed on the Terrorist Exclusion List (TEL), “stolen,” access authority, and the like.

The programmer is capable of adding information to a file after a match to a barcode and or a reference. The programmer is also capable of sending information derived from the match to another database within the system, to a user to terminal, to another system, and the like.

### BRIEF DESCRIPTION OF THE DRAWINGS

FIG. 1 is a schematic depiction of the components and the interaction of the system.

### DESCRIPTION OF THE PREFERRED EMBODIMENTS

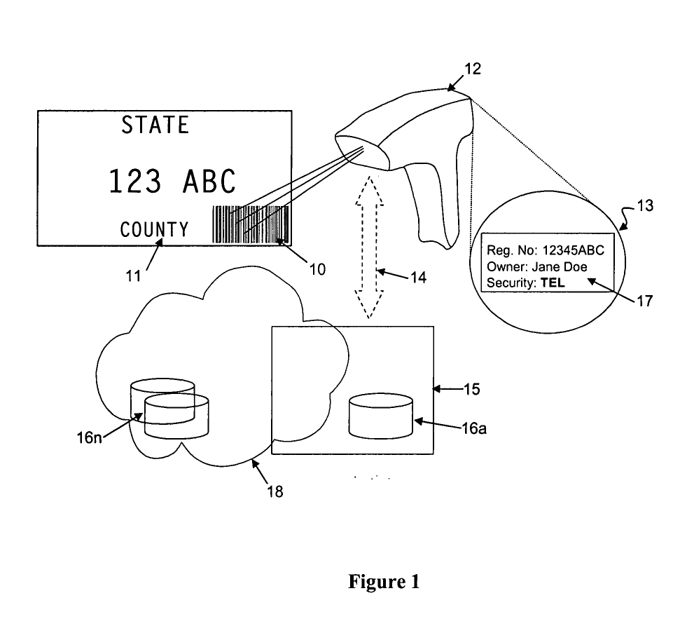

The invention encompasses a system to provide information associated with a vehicle. As shown in FIG. 1, a barcode 10 is located on a vehicle, such as on a license plate 11. A barcode scanner 12 scans the barcode and decodes the information in the barcode. The information may be directly displayed on a display 13, which may be part of the scanner or may be a separate component. Alternatively, the scanned information may include a reference that is transmitted 14 to a processor 15. The processor matches the reference to one or more file in one or more database 16a-n and returns the data in the matched files 17 to the display 13. The processor 15 may be contained, or may be connected to other databases, including those linked in a communications network, such as the Internet 18.

The barcode information can be displayed directly, or used to locate data housed in local databases and/or national and international databases, connected directly, in an intranet, or via the communications network. The uses include, but are not limited to, accessing approval information, crosschecking for violations, criminal records, or stolen vehicles, determining relevant information about the owner, and the like. The rapid and accurate transmission of the barcode information can assist in the making of fast, accurate decisions.

The term “vehicle” as used herein can include any motorized mode of transportation that requires a license, such as an automobile, motorcycle, truck, boat, etc.

In one embodiment, a barcode is created to represent information about the vehicle, including information regularly appearing on a registration, such as VIN, year, make and model, color, owner, owner address, owner's date of birth, county, state, the registration number appearing on the plate, etc. Additional information may be encoded in the barcode.

In an embodiment, a preexisting barcode is linked by a reference to a vehicle through registration of the vehicle. At the time of registration, a computer data file identifiable as matching to the barcode reference is created and populated with information about the vehicle, including information regularly appearing on a registration, such as VIN, year, make and model, color, owner, owner address, owner date of birth, county, state, the registration number appearing on the plate, etc. Additional information may be added to the file at the time of creation. The file is saved in a database accessible by a processor. For a person re-registering a vehicle, or an existing vehicle transfer, the file may be accessed and updated to match a new barcode.

The barcode may be located on the license plate of the vehicle. The barcodes may be mandatory or voluntarily placed on the vehicle.

A barcode scanner is located at a given location, which can be stationary, such as on a building, a parking garage entrance, a gated entry, etc., or mobile, such as on a motorcycle, a person, a bicycle, a horse, a helicopter, an airplane, an automobile, a truck, a boat, a snowmobile, a golf cart, etc. The scanner may manned or unmanned and be hand-held or fixed. The scanner may be linked wirelessly or wired to a processor.

In one embodiment, the scanner is mobile and located in a law enforcement vehicle. When a target vehicle is determined, the scanner is directed to the vehicle's barcode. A scanner may scan in one dimension or in multiple dimensions. The scanner decodes the barcode and transfers the scanned information directly to a display or, alternatively, to a processor. Where the directly displayed information is unable to be decoded, an error message is displayed on the display. Information transferred to the processor is compared to files located in one or more databases. The processor may be linked to other databases directly or though a communications network, such as the Internet. If no file is found, the processor returns a message to a display indicating such.

When the processor locates a file, the file information is transferred to the display and displayed. Where more than one file is located, the processor may be programmed to return only certain files to the display. The system provides real-time security alerts, such as those that assist a law enforcement officer or other security person to take appropriate precautions. The processor may be programmed to return files based upon the scanner, the location of the scanner, the request, and the like.

The information from the database file displayed on the display may be updated at the scanner location.

The system can also be used to transmit data to a third party or location, such as a check against or an addition to a second database, such as but not limited to, databases associated with the Patriots Act, Amber Alerts, FBI lists, international lists, and the like.

In an embodiment, the barcode is compared to preexisting files for uses such as determine whether a vehicle has authorization, such as entering a gated community, parking facility, secured facility, or the like. In this embodiment, the display is programmed to signal the user whether a match has been found.

In an embodiment, the barcode is coded with the weight of a trailer or wagon after loading. A scanner located at the weigh station can be used to let the vehicle by-pass the station or verify the weight of the trailer.

The system allows for automation of access control and security functions. Here, when the scanned barcode information or reference matches existing information, the processor sends a signal to a physical device that automatically allows or prevents access without human intervention.

One skilled in the art will understand that the description of the present invention herein is presented for purposes of illustration and that the design of the present invention should not be restricted to only one configuration or purpose, but rather may be of any configuration or purpose which essentially accomplishes the same effect.

The foregoing descriptions of specific embodiments and examples of the present invention have been presented for purposes of illustration and description. They are not intended to be exhaustive or to limit the invention to the precise forms disclosed, and obviously many modifications and variations are possible in light of the above teachings. It will be understood that the invention is intended to cover alternatives, modifications and equivalents. The embodiments were chosen and described in order to best explain the principles of the invention and its practical application, to thereby enable others skilled in the art to best utilize the invention and various embodiments with various modifications as are suited to the particular use contemplated. It is therefore to be understood that within the scope of the appended claims, the invention may be practiced otherwise than as specifically described herein.

1. A system to obtain information associated with a vehicle comprising:
a barcode attached to a vehicle, said barcode encoded with information;
a scan engine, said scan engine capable of scanning the barcode and decoding the information;
a display communicatively linked to the scan engine, said scan engine capable of transferring the decoded information to the display; and
a processor, said processor communicatively linked to the scan engine, the display, and to one or more database; said processor comparing the decoded information to data in the one or more database and transmitting linked data to the display.

2. The system of claim 1 wherein the barcode is not visible to the human eye.

3. The system of claim 1 wherein the decoded information is a reference, said reference used to determine linked data.

4. The system of claim 1 wherein the display displays an alert based on the linked data.

5. The system of claim 1 wherein the scan engine is mobile and located in a law enforcement vehicle.

6. The system of claim 1 wherein the linked data is related to the Patriots Act, an Amber Alert, an FBI list, and an international list.

7. The system of claim 1 wherein new data is added to linked data.

8. The system of claim 7 wherein the new data is transmitted to or from one or more database.

9. The system of claim 8 wherein the database is related to one of the Patriots Act, an Amber Alert, an FBI list, and an international list.

10. The system of claim 1 wherein linked data is used to allow at least one authorization.

11. The system of claim 1 wherein linked data is used to verify a weight.

12. The system of claim 1 wherein the data is one of a VIN, year, make, model, color, owner, owner address, owner's date of birth, county, state, and a registration number appearing on a vehicle registration plate.

13. The system of claim 1 wherein the information encoded is selected from a VIN, year, make, model, color, owner, owner address, owner's date of birth, county, state, and a registration number appearing on a vehicle registration plate.

14. A method of associating data with a vehicle comprising
creating a barcode;
encoding information into the barcode;
attaching the barcode to a vehicle;
scanning the barcode with a scanner, said scanner capable of decoding and transferring the information to a processor communicatively linked to the scanner;
matching the decoded information to one or more file in a database; and
transmitting data in the matched file to a display.

15. The method of claim 14 wherein the barcode is not visible to the human eye.

16. The method of claim 14 wherein the decoded information is a reference, said reference used in matching to the one or more file.

17. The method of claim 14 wherein the file contains data selected from VIN, year, make and model, color, owner, owner address, owner date of birth, county, state, and a registration number appearing on the plate.

18. The method of claim 14 wherein the encoded information is selected from a VIN, year, make, model, color, owner, owner address, owner's date of birth, county, state, and a registration number appearing on a vehicle registration plate.

19. The method of claim 14 wherein the data is related to one of the Patriots Act, an Amber Alert, an FBI list, and an international list.

20. The method of claim 14 further comprising adding new data to the matched file.

21. The method of claim 20 further comprising transmitting and or receiving new data to or from one or more file in one or more database.

22. The method of claim 21 wherein the file is related to one of the Patriots Act, an Amber Alert, an FBI list, and an international list.

23. The method of claim 14 further comprising displaying an alert based on the data in the matched file.

24. The method of claim 14 wherein the scanner is mobile and located in a law enforcement vehicle.

25. The method of claim 14 further comprising allowing authorization based upon the data in the matched file.

26. The method of claim 14 further comprising verifying a weight.
